(19) United States
(12) Patent Application Publication
(10) Pub. No.: US 2021/0387116 A1
(43) Pub. Date: Dec. 16, 2021

(54) ROTARY PRESSURE FILTER MODULE

(71) Applicant: BHS-Sonthofen GmbH, Sonthofen (DE)

(72) Inventors: Jürgen MAURER, Immenstadt (DE); Wolfgang SÜSS, Sonthofen (DE); Detlef STEIDL, Ofterschwang (DE); Steffen KÄMMERER, Immenstadt (DE)

(73) Assignee: BHS-Sonthofen GmbH, Sonthofen (DE)

(21) Appl. No.: 17/290,952

(22) PCT Filed: May 3, 2019
(86) PCT No.: PCT/EP2019/061345

§ 371 Date: May 3, 2021

(30) Foreign Application Priority Data
Nov. 6, 2018 (DE) 10 2018 218 907.2

(51) Int. Cl. B01D 33/80; B01D 33/09; B01D 33/46; B01D 33/60; B01D 33/66

(52) U.S. Cl. CPC B01D 33/804; B01D 33/09; B01D 33/463; B01D 33/801; B01D 33/60; B01D 33/663; B01D 33/466

(57) ABSTRACT

The invention relates to a rotary pressure filter module (100) which comprises a rotary pressure filter (200) having a plurality of supply lines (302, 318, 330) for supplying a suspension, washing medium, drying medium, and optionally other operating media to be filtered and having a plurality of discharge lines (314, 326, 348) for discharging mother filtrate, washing filtrate, and filter cakes, different sensor devices (306/308/310, 322/324, 334/336, 316, 328, 349) being assigned to the supply lines and the discharge lines, and adjusting devices also being assigned to the supply lines, the rotary pressure filter module (100) additionally comprising a control device (400) which is connected to the sensor devices and the adjusting devices. According to the invention, the decentralised control device (400) assigned to the rotary pressure filter (200) is arranged on the rotary pressure filter (200) or in its immediate vicinity and has a signal input via which it can be brought into data exchange connection with a central control device, which does not belong to the rotary pressure filter module (100), of a higher-level production system.

The invention relates to a rotary pressure filter module according to the preamble of claim 1.

In a manner known per se, a rotary pressure filter comprises a filter housing in which a filter drum which rotates around an axis of rotation by means of a rotary drive is mounted. On its outer circumferential surface, the filter drum has a plurality of filter cells which are open towards the filter housing. At its axial ends, the filter drum is sealed off from the filter housing by stuffing boxes. In addition, separating elements extending parallel to the axis of rotation are provided in the filter housing, which separating elements divide the rotary pressure filter in the circumferential direction into a plurality of segment zones which are separated so as to be pressure-tight and which fulfil different functions, in particular filtration, filter cake washing, filter cake drying, as well as filter cake discharge and filter cell preparation. The usual working pressure of such a rotary pressure filter is approximately 3 bar, in the case of high-performance filters up to approximately 7 bar.

The suspension to be filtered, the washing medium and the drying medium are supplied via corresponding supply lines that open into the filter housing, while the mother filtrate, the washing filtrate and the drying medium are discharged via discharge lines that extend from the bottom of the filter cells. A first portion of the discharge lines rotates with the filter drum and ends in a control head of the rotary pressure filter, where it merges into a second portion fixed to the housing. The filter cake is usually discharged radially outwards at ambient pressure through an opening in the filter housing, optionally supported by a scraper. The filter cloth, which can be made of a plastics fabric or a metal fabric depending on the application, can then be rinsed and pressed against the support mesh of the filter cell again.

The washing of the filter cake can take place in one or more stages. In particular, it can comprise displacement washing and/or counter-current washing and/or circulation washing and/or slurrying and/or solvent exchange and/or steaming and/or extraction. Correspondingly, the segment zone assigned to filter cake washing can be divided into one or more sub-zones. Furthermore, one or more supply lines for one or more washing media, for example washing liquid, steam or the like, can be provided.

If desired, the filter cake washing can also be preceded by pre-dehumidification.

The rotary pressure filter of the rotary pressure filter module according to the invention also has this design. With regard to further details of the basic design of the rotary pressure filter, reference is made to DE 100 05 796 A1 by the applicant, the disclosure of which is hereby incorporated by reference in its entirety.

Rotary pressure filters of the type described above are usually used as part of a higher-level production system, in particular in the field of industrial chemistry, fine chemistry, pharmacy and the food industry.

Known rotary pressure filters have control panels having display units for displaying the values of the process parameters monitored by the sensor devices, as well as input units for entering target values for the adjusting devices influencing these process parameters. Such a control panel, however, does not constitute a “control device” within the meaning of the present invention, since it merely forwards commands entered by an operator to the respective adjusting devices.

In addition, it is also known to connect the rotary pressure filter module to the central control device of a production system, as a result of which this central control device is “assigned” to the rotary pressure filter module within the meaning of the present invention. This central control device forms the process management level of the production system and uses the process parameters specified for the entire production system to determine the setpoint values of the process parameters required to operate the rotary pressure filter module, transmits them to the associated adjusting devices of the rotary pressure filter module and monitors the setting thereof using the process parameters detected by the sensor devices.

Due to the increasing automation of modern production systems, it is necessary to monitor more and more process parameters of the production system and thus also of the rotary pressure filter module by means of appropriate sensors, and to supply the detection signals of the sensors via suitable data lines to the control device of the production system, which uses these signals to determine manipulated variables for the control devices of the production system and transmits these to the adjusting devices via suitable data lines. This leads to an increasing complexity of the tasks to be fulfilled by the control device of the production system, as well as to an increased cost and maintenance effort for the necessary data lines.

It is the object of the invention to remedy this.

This object is achieved according to the invention by a rotary pressure filter module of the type mentioned at the outset, in which the decentralised control device assigned to the rotary pressure filter is arranged on the rotary pressure filter or in its immediate vicinity and has a signal input via which it can be brought into data exchange connection with a central control device, which does not belong to the rotary pressure filter module, of a higher-level production system.

Already at this point it should be noted that when it is mentioned in connection with the present invention that “the control device is arranged on the rotary pressure filter”, this means that the control device is arranged within a hypothetical cuboid of minimal volume in which the rotary pressure filter, including the drive unit thereof, can still be accommodated, one main direction of which cuboid extends parallel to the axis of rotation of the filter drum, and one surface of which extends parallel to the substrate on which the rotary pressure filter rests. It should also be noted that when it is mentioned in connection with the present invention that “the control device is arranged in the immediate vicinity of the rotary pressure filter”, this means that the distance between the geometric centre of the rotary pressure filter, including the drive unit thereof, and the geometric centre of the decentralised control device is at most equal to the length of the longest space diagonal of the aforementioned hypothetical minimum cuboid.

It should also be noted that when it is mentioned in connection with the present invention that a sensor device is “assigned” to a supply or discharge line, this does not necessarily mean that the sensor device is arranged in this line. Rather, it can also be arranged in a portion of the rotary pressure filter into which this line opens or from which this line starts.

According to the invention, the rotary pressure filter module is equipped with its own control device, which forms a decentralised control device in relation to the entire production system, which is designed and intended to relieve the central control device of the entire production system from control tasks relating to the rotary pressure filter.

As a result, the central control device of the production system only needs to transmit an operating start signal to the decentralised control device of the rotary pressure filter module via the data exchange connection in the simplest case, i.e. switch on the rotary pressure filter module. However, it is also possible for the central control device of the production system to transmit further information to the decentralised control device of the rotary pressure filter module via the data exchange connection in addition to the operating start signal, for example information about the production specifications, in particular the type of suspension to be filtered, which output quantity of filter cake and which quality thereof is expected as part of the entire production process, and whether it is expected to operate continuously or in batches. For this purpose, the decentralised control device can comprise an input unit which is designed to receive messages from the central control device in a data format containing this information.

The data exchange connection can advantageously be a standardised data exchange connection, for example a data exchange connection such as is provided by an MTP (module type package).

In response to the operating start signal, the decentralised control device determines the manipulated variables for the adjusting devices on the basis of the data provided by the sensor devices, optionally taking into consideration the at least one piece of information received from the central control unit. For this purpose, the decentralised control device can comprise a manipulated variable determination unit.

In principle, it is conceivable that the manipulated variable determination unit is connected to these adjusting devices in order to transmit the manipulated variables in the form of control signals to the adjusting devices. However, it is more advantageous if the manipulated variable determination unit is designed to transmit the manipulated variables determined thereby to a monitoring unit, which forwards them to the adjusting devices and is also designed to monitor compliance with the determined manipulated variables on the basis of the detection signals received from the sensor devices and, if necessary, to output corrective control signals to the adjusting devices.

It should be added in this connection that the manipulated variable determination unit can also be designed to determine the manipulated variables for the adjusting devices not only in response to the operating start signal, but also during ongoing operation of the rotary pressure filter module, and to continuously forward the determined manipulated variables to the monitoring unit.

Finally, the decentralised control device can also comprise an output unit which is designed to transmit information about the operation of the rotary pressure filter module to the central control device of the entire production system. The output unit can be connected to the manipulated variable determination unit and/or the monitoring unit. For example, if the manipulated variable determination unit should determine that the production specifications cannot be met or can only be met with limited filter cake quality, a corresponding warning message can be sent to the central control device of the production system.

As can be seen from the discussion above, the sensor signals of the sensor devices therefore do not need to be transmitted to the central control device of the production system, and this does not need to determine the control signals for the adjusting devices and to transmit these signals to the adjusting devices. By arranging the decentralised control device on the rotary pressure filter or in the immediate vicinity thereof, a plurality of data lines between the rotary pressure filter and the central control device of the production system can be dispensed with, and the central control device of the production system can be relieved of a large number of tasks.

In addition, the provision according to the invention of a decentralised control device facilitates the integration of the rotary pressure filter into an existing production system. On the one hand, the control program for the rotary pressure filter does not need to be integrated into the control program of the central control device of the production system, since the rotary pressure filter controls itself by means of its decentralised control device. On the other hand, the rotary pressure filter module according to the invention can also be integrated in production systems having a low-performance central control device, into which systems the rotary pressure filter could not be integrated up to now or could be integrated only with great effort.

In principle, the manipulated variable determination unit can be designed to determine the manipulated variables by means of a predetermined determination program. This determination program can comprise a plurality of sub-programs, each of which is assigned to a predetermined suspension to be filtered and determines the manipulated variables depending on the detection signals provided by the various sensor devices, specifically not only the sensor devices already mentioned above, but also the sensor devices to be discussed below.

For example, the determination program can be built in the manner of a fixedly predetermined decision tree. However, it is also possible for the determination program to access at least one multidimensional value table in order to determine the manipulated variables. Hybrid forms are also conceivable. For example, a decision tree could be used to determine which value table or which value tables should be accessed.

However, the manipulated variable determination unit is preferably designed as a manipulated variable determination unit equipped with artificial intelligence, it being possible for the artificial intelligence to comprise, for example, at least one adaptive decision tree and/or at least one neural network, which are generated on the basis of training data. Adaptive decision trees have the advantage of requiring a smaller amount of training data than neural networks. Neural networks, on the other hand, have the advantage of greater precision when determining the manipulated variables. It is also possible to combine the advantages of decision trees with those of neural networks. For example, one or more weak decision-making branches of a decision tree can be replaced by a neural network. Additionally or alternatively, the precision of decision trees can be increased by providing a decision forest, that is to say a plurality of, preferably randomly generated, decision trees that decide according to the majority principle.

Because the decentralised control device can be equipped with artificial intelligence, it is possible to design the rotary pressure filter module as an autonomously operating unit that controls itself faster and more safely than a person could. In particular, the artificial intelligence is able to take into consideration a much larger number of parameters, in particular detection data supplied by the sensor devices, in the control, to relate them to one another and to draw conclusions therefrom for the control of the rotary pressure filter, namely with additional consideration of production specifications via the central control device of the entire production system. For example, both fluctuating operating conditions, such as fluctuations in throughput and/or pressure and/or temperature and/or solids content and/or viscosity and/or particle size distribution, and the condition of the rotary pressure filter, in particular the state of wear thereof, can be taken into consideration. In other words, the artificial intelligence can generate “smart data” from the “big data” provided by the plurality of sensor devices, in order to allow optimised and safe operation of the rotary pressure filter. As a result, unforeseen downtimes or failures of the rotary pressure filter due to overuse and/or excessively slow or even incorrect reactions to changes, such as those that in particular occur more frequently during the night shift, can be reduced and overall the availability of the rotary pressure filter can be increased and at the same time maintenance costs can be reduced.

In principle, it is conceivable that the artificial intelligence can be designed as a static intelligence which no longer adapts itself once it has been trained.

Preferably, however, the artificial intelligence can be designed as adaptive artificial intelligence, which learns from the experience gained during ongoing operation of the rotary pressure filter and continues to develop. For this purpose, the decentralised control device can comprise a memory unit which is intended to store a parameter data set corresponding to the relevant operating constellation at predetermined time intervals. It is also conceivable to store at least one parameter data set, preferably a plurality of such parameter data sets, that have occurred on one or more identical pressure filter modules in the memory unit, at the start of putting the rotary pressure filter module in question into operation. As soon as the entire storage space of the memory unit is occupied with parameter data records, newly added parameter data records can overwrite parameter data records that have already been stored, with older parameter data records preferably being overwritten first.

Using the parameter data sets stored in the memory unit, it is possible to train the artificial intelligence at predetermined time intervals, for example once a day.

Additionally or alternatively, however, it is also conceivable that the control unit comprises a communication unit which is designed to transmit parameter data sets, preferably in the context of an Internet-based application and/or by telecommunication, to a service centre and to store them there in a suitable database, for example a NoSQL database, in particular a document-oriented NoSQL database, such as a Mongo database, for example in the csv data format.

On the basis of this and other stored data, the service centre can provide various services for the operator of the rotary pressure filter module as part of a customer portal:

For example, a copy of the artificial intelligence of the manipulated variable determination unit can be stored in a computer of the service centre, which artificial intelligence can be trained on the basis of the transmitted parameter data sets, if desired taking into consideration experiences made with other rotary pressure filters, so that the newly trained form of the artificial intelligence only has to be fed back to the manipulated variable determination unit of the rotary pressure filter. The ongoing operation of the rotary pressure filter does not have to be interrupted, however. Rather, only the updating of the manipulated variables monitored by the monitoring unit needs to be suspended by the manipulated variable determination unit during the feedback time.

In addition, the service centre can evaluate the parameter data sets in various ways. For example, key figures and correlations of certain process parameters can be determined, displayed by means of visualisation tools such as Tableau® and made available to the operator of the rotary pressure filter module, preferably via an Internet-based customer portal, and displayed in a dashboard if desired. This allows the operator of the rotary pressure filter module not only to monitor the productivity of the rotary pressure filter, but also to predict and thus flexibly plan maintenance intervals. Finally, the operator of the rotary pressure filter module can also be provided with information about the relationship between productivity and the length of the maintenance intervals. For example, he could be informed that he can keep to the planned maintenance interval if he operates the rotary pressure filter with only 80% of the maximum achievable productivity, while the maintenance interval would be halved if he increases productivity to 100%. The operator of the rotary pressure filter module can also be informed of the effects on the consumption of operating media, for example washing and drying media.

Furthermore, the parameter data sets in the service centre can be analysed to determine whether a problem has occurred with the rotary pressure filter or whether it is in the process of being initiated. This makes it possible in particular to make the maintenance intervals more flexible, for example to individually adapt the refilling or replacement of lubricant and the replacement of wear parts, for example sealing elements, to the operation of the respective rotary pressure filter.

This can also comprise a comparison of the wear detected by means of the sensor devices with a wear predicted on the basis of a wear model, it being possible for this wear model to also be based on artificial intelligence, i.e. at least one decision tree and/or a neural network. Taking delivery times and the like into consideration, a pre-warning period for maintenance work can also be set.

The sensor devices and adjusting devices of the rotary pressure filter can have the most varied of designs and the most varied of functions. At this point it should be noted that the terms “first”, “second”, “third” etc. serve only to distinguish between the sensor devices and adjusting devices and are due to the order in which they are named in the claims, but are not intended to indicate a hierarchy or any other type of order of these devices. If the order in which they are named were changed, they could also be selected differently as desired.

The first sensor device assigned to the first supply line for supplying suspension to be filtered can comprise a flow rate sensor, for example a mass flow sensor and/or a volumetric flow sensor, and/or a pressure sensor and/or a temperature sensor and/or a solids content sensor and/or a density sensor and/or a viscosity sensor and/or a particle size distribution sensor.

The fourth sensor device assigned to the first discharge line for discharging mother filtrate can comprise a conductivity sensor and/or a turbidity sensor and/or a pH value sensor.

The second sensor device assigned to the second supply line for supplying washing medium can comprise a flow rate sensor, for example a mass flow sensor and/or a volumetric flow sensor, and/or a pressure sensor and/or a temperature sensor.

The fifth sensor device assigned to the second discharge line for discharging washing filtrate can comprise a conductivity sensor and/or a turbidity sensor and/or a pH value sensor.

The third sensor device assigned to the third supply line for supplying drying medium, for example drying gas, can comprise a flow rate sensor, for example a mass flow sensor and/or a volumetric flow sensor, and/or a pressure sensor and/or a temperature sensor.

Furthermore, the rotary pressure filter can comprise a cake thickness sensor in the drying zone thereof. As can easily be seen, the thickness of the filter cake at a given rotation speed of the filter drum is a measure of the quantity of filter cake produced. The cake thickness sensor can, for example depending on the material of the filter cake, be an optically and/or mechanically and/or capacitively working sensor, for example a cake thickness sensor as described in the German patent application 10 2018 205 236.0 by the applicant, the relevant disclosure of which is hereby incorporated by reference in its entirety.

Furthermore, the rotary pressure filter can have a fourth discharge line for discharging the drying medium, which discharge line can be assigned a seventh sensor device, for example a pressure sensor. In addition, this fourth discharge line can be connected to a separating device which can be designed to separate the drying medium from any residual filtrate discharged from the filter cells by said medium.

The sixth sensor device assigned to the third discharge line for discharging filter cakes can comprise a residual moisture sensor. The residual moisture in the filter cake is a criterion for the quality of the filtration process. The lower the residual moisture in the filter cake, the better the previous filtration process.

In the third discharge line, which can be designed as a discharge chute, for example, a scraper can also be arranged which can be actuated by the supply of pressure medium, for example compressed gas, in particular compressed air. The pressure medium can be supplied to the actuating device of the scraper via a fourth supply line, to which an eighth sensor device can be assigned which can comprise, for example, a pressure sensor.

To facilitate the discharge of the filter cake, in particular the detachment thereof from the filter cells, the rotary pressure filter can comprise a fourth supply line for supplying blowback medium, for example blowback gas, in particular blowback air, which supply line is connected to the bottom of the filter cells. The supply line for supplying blowback medium can be assigned an eighth sensor device which can comprise, for example, a pressure sensor.

Furthermore, the rotary pressure filter can comprise a fifth supply line for supplying cloth rinsing medium, for example cloth rinsing liquid, which can be sprayed onto the filter cloth, for example by means of a spray nozzle, in order to detach any remaining filter cake residues. A ninth sensor device can also be assigned to the supply line for supply the cloth rinsing medium, which sensor device can comprise, for example, a pressure sensor and/or a pressure flow rate sensor, in particular a mass flow sensor and/or a volumetric flow sensor.

To facilitate the cleaning of the filter cloth, the rotary pressure filter can comprise a sixth supply line for supplying blowback medium, for example blowback gas, in particular blowback air, which supply line is connected to the bottom of the filter cells. The supply line for supplying blowback medium can be assigned a tenth sensor device which can comprise, for example, a pressure sensor.

In order to be able to place the filter cloth against the support mesh of the filter cells again to prepare the filter cell for the next filtration cycle, the rotary pressure filter can comprise a seventh supply line for supplying pressing medium, for example pressing gas, in particular pressing air, which is connected to the filter housing. The supply line for supplying pressing medium can be assigned an eleventh sensor device which can comprise, for example, a pressure sensor.

In addition, a pressure sensor for detecting the pressure prevailing in the filter cells can be provided in at least one segment zone of the rotary pressure filter.

In a further development of the invention, the drive device of the rotary pressure filter, regardless of its exact design, can be assigned a twelfth sensor device which can comprise, for example, a rotational speed sensor and/or a drive power sensor and/or a torque sensor and/or a sensor for the power consumed by the drive device.

According to the invention, adjusting devices can also be assigned to each of the fourth to seventh supply lines. All of the adjusting devices can be formed by a flow rate adjustment valve and/or by a pump that can be adjusted to the supply quantity.

Finally, the sealing elements arranged between the filter drum and the filter housing can be assigned further sensor devices, which can each comprise, for example, a wear sensor.

For example, the axial ends of the filter drum can be sealed off from the filter housing by sealing elements extending in the circumferential direction. A sealing element extending in the circumferential direction can be formed by a stuffing box, as known for example from DE 101 57 297 A1 and DE 10 2007 002 931 A1 by the applicant, and/or by a sliding ring and hose ring combination, as known for example from DE 100 05 796 A1 by the applicant. As is known, for example, from the subsequently published German patent application 10 2017 221 088.5 by the applicant, the relevant disclosure of which is hereby incorporated by reference in its entirety, such a sealing element can be assigned a re-adjusting device. According to the invention, this re-adjusting device can be remotely actuated by means of at least one power device and can comprise a sensor device which, for example, detects the adjustment distance by which the re-adjusting device has been adjusted by means of the at least one power device and/or the contact pressure of the re-adjusting device. Particularly in the case of a stuffing box packing, the pressure sensors can be arranged in different positions, for example on the innermost packing ring toward the packing shoulder and/or on the outer diameter of the packing space and/or at the contact point of the stuffing box gland to the stuffing box packing. Alternatively, it is also conceivable to detect the preload of the re-adjusting screws of the re-adjusting device and/or to measure the leakage permitted by the sealing element.

Furthermore, the wear of the separating elements extending parallel to the axis of rotation of the filter drum can be measured by means of an inductively operating sensor device, for example a wear sensor as described in the German patent application 10 2018 205 237.9 by the applicant, the relevant disclosure of which is hereby incorporated by reference in its entirety.

Further sensor devices can be assigned, for example, to the rotary bearing arrangement of the filter drum, which arrangement is usually designed as deep groove ball bearings or spherical roller bearings. For example, a fill level sensor can be provided on the lubricant container of the rotary bearing. It is also conceivable to monitor the condition of the lubricant in the rotary bearing arrangement, in particular the moisture content thereof, by means of a sensor based on infrared spectroscopy.

It should be added that the decentralised control device can be provided in a switch cabinet arranged in the immediate vicinity of the rotary pressure filter. This has the advantage of better accessibility to the decentralised control device.

It should also be added that the completeness of the ejection of the filter cake can also be detected. This can take place, for example, directly, for example by means of an image evaluation of the filter cloth after the filter cake has been ejected, or indirectly, for example by detecting the degree of turbidity of the cloth rinsing medium.

The invention will be explained in more detail below on the basis of an embodiment with reference to the accompanying drawings, in which:

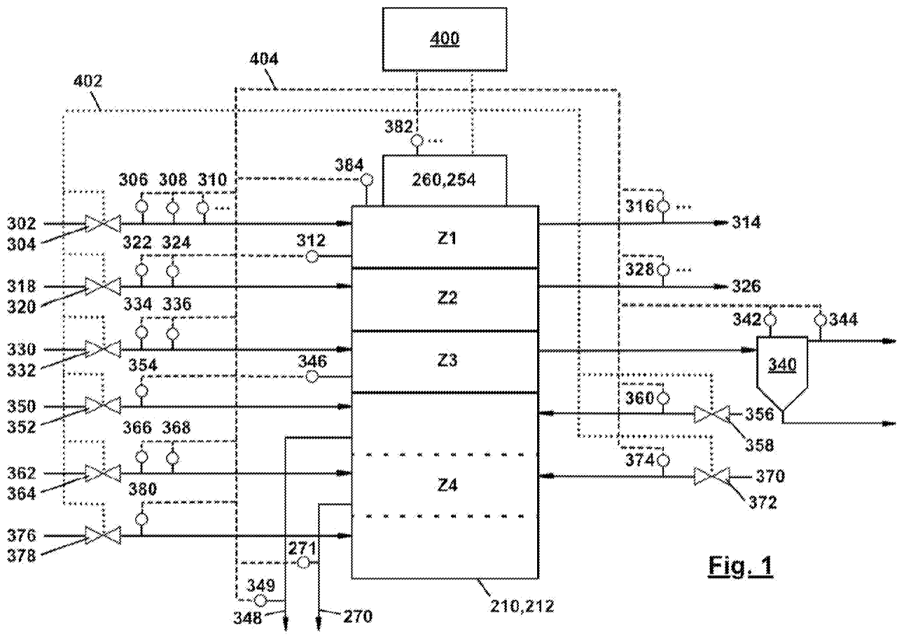

FIG. 1 is a roughly schematic illustration of a rotary pressure filter module according to the invention;

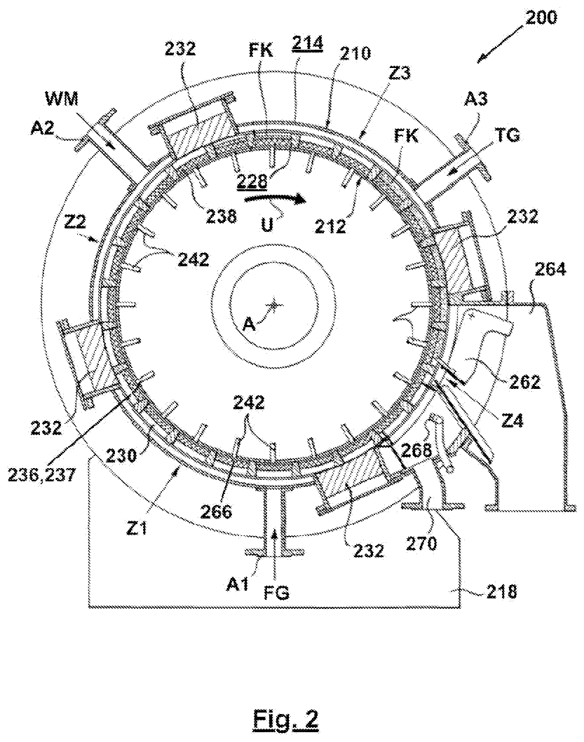

FIG. 2 is a sectional view, taken orthogonally to the axis of rotation of the filter drum thereof, of a rotary pressure filter as can be used in the rotary pressure filter module according to the invention;

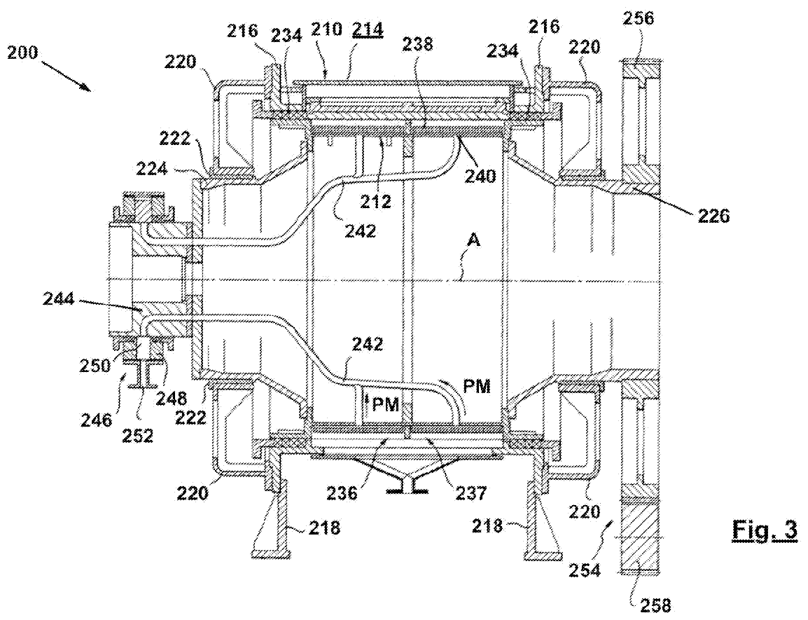

FIG. 3 is a sectional view of the rotary pressure filter of FIG. 2 taken along the axis of rotation of the filter drum; and

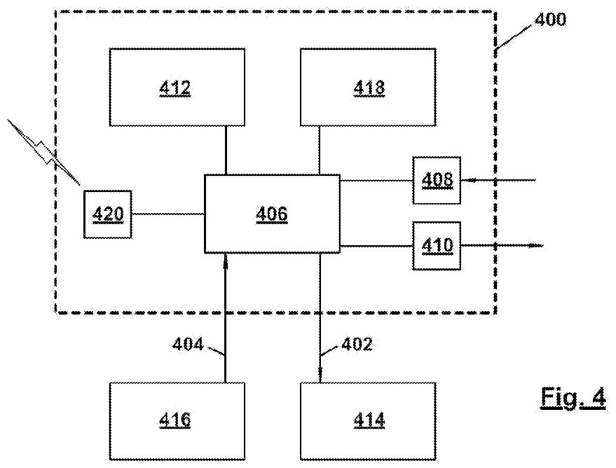

FIG. 4 is a schematic illustration of the design of a decentralised control device as can be used in the rotary pressure filter module according to the invention.

In FIG. 1, a rotary pressure filter module is very generally denoted by 100. The rotary pressure filter module 100 comprises a rotary pressure filter 200, which is also shown in FIGS. 2 and 3, and a control device 400, the schematic design of which is shown in FIG. 4.

As shown in particular in FIGS. 2 and 3, the rotary pressure filter 200 comprises a filter housing 210 and a filter drum 212 rotating in the filter housing 210 about an axis of rotation A. The filter housing 210 comprises a housing casing unit 214 having end rings 216. The housing casing unit 214 is supported on a foundation (not shown) by means of a filter housing support 218 attached to the end rings 216. End shields 220, which comprise rotor bearings 222, are fastened to the filter housing 210. The filter drum 212 is rotatably mounted in the rotor bearings 222 by means of two end portions 224 and 226. The filter drum 212 comprises a rotor casing unit 228. The rotor casing unit 228 and the housing casing unit 214 form a space 230 therebetween. This space 230 is subdivided into space zones Z1, Z2, Z3, Z4, also called segment zones but simply referred to as “zone” in the following, by zone separating means 232. At its axially spaced ends, the space 230 is sealed by sealing assemblies 234.

The outer face of the rotor casing unit 228 facing the space 230 is designed as a cell structure. This cell structure comprises filter cells 236 and 237. A filter means 238 is arranged in each filter cell 236, 237 and covers a discharge opening 240. The discharge openings 240 of a pair of filter cells 236, 237 are connected to the core 244 of a control head 246, which circulates with the filter drum 212, by a discharge line 242 which also circulates with the filter drum 212. The circulating core 244 is arranged on the end portion 224 of the filter drum 212 in a rotationally fixed manner. The control head 246 also comprises a stator 248, which is supported on the filter housing 210 against rotation and surrounds the core 244. Ring segment chambers 250 are formed in the stator 248, each of the ring segment chambers 250 corresponding in its circumferential length to the circumferential length of one of the zones Z1 to Z4. A stationary discharge line 252 leads from the ring segment chambers 250 assigned to zones Z1 to Z3 to a relevant collecting space (not shown), while the ring segment chamber 250 assigned to zone Z4, as will be explained in more detail below, can be connected to a supply line for blowback air.

The filter drum 212 is driven by a transmission unit 254. The transmission unit 254 comprises a large gear wheel 256 and a drive pinion 258. The drive pinion 258 is driven by an electric motor 260. The speed of the electric motor 260 is transmitted into slow speed by the transmission unit 254, so that the filter drum 212 rotates at a speed of the order of magnitude of 0.5 to 4 revolutions per minute. The direction of rotation is indicated by an arrow U in FIG. 2.

In FIG. 1, the zones Z1 to Z4 are shown roughly schematically as rectangles. The left-hand side of these rectangles in FIG. 1 corresponds to the outer circumferential surface of the filter drum 212, while the right-hand side in FIG. 1 corresponds to the radially inner side of the filter drum 212 connected to the discharge lines 242.

The rotary pressure filter 200 described above operates, for example, as follows:

A supply fitting A1 of the rotary pressure filter 200 is connected to a supply line 302 for filter material FG. The filter material FG can be, for example, a liquid-solid suspension, the solids content of which is to be separated from the liquid. The filter material FG passes through the supply fitting A1 into the filtration zone Z1 and spreads there.

The amount of filter material FG that reaches the filtration zone Z1 per unit of time is determined via a metering valve 304, which receives its setting commands from the decentralised control device 400 via a control signal line 402. The supply line 302 is also assigned a pressure sensor 306 and a flow rate sensor 308, for example a mass flow sensor and/or a volumetric flow sensor. If necessary, the supply line 302 can also be assigned further sensors which detect further properties of the filter material FG, for example a temperature sensor and/or a solids content sensor and/or a density sensor and/or a viscosity sensor and/or a particle size distribution sensor. These further sensors are represented in FIG. 1 by a sensor 310 and three points. Finally, the pressure that is established in the filtration zone Z1 can also be detected via a pressure sensor 312.

The liquid component of the filter material FG is pressed through the filter means 238 of the cells 236, 237, such that the solids content in the supply spaces 266 collects radially outside the filter means 238 as filter cake FK, and passes as filtrate through the discharge openings 240 into the discharge lines 242. The filtrate flow is indicated in FIG. 3 by the arrows PM. If FIG. 2 is considered a snapshot during the continuous rotary movement of the filter drum 212, then at the corresponding moment all the filter cells 236, 237, which are radially opposite the filtration zone Z1 and are open towards said zone, are connected to the supply fitting A1, and furthermore the discharge openings 240 of these cells 236, 237, which are in connection with the filtration zone Z1, are each connected to the core 244 of the control head 246 via a discharge line 242 and are further connected via the stator 248 of the control head 246 to the stationary discharge line 252, which leads to a filtrate collecting container (not shown).

The circulating discharge lines 242 located in the filtration zone Z1 form a first portion of a discharge line 314 (see FIG. 1) assigned to the filtration zone Z1, while the stationary discharge line 252 forms a second portion of this discharge line 314. Various sensors can also be assigned to the discharge line 314, for example a conductivity sensor and/or a turbidity sensor and/or a pH value sensor, which are represented in FIG. 1 by the sensor 316 and three points.

In the course of the further rotation of the filter drum 212, the cell group 236/237 is separated from the filtration zone Z1 as it passes the zone separating means 232 and comes into connection with the washing zone Z2, in which the filter cake FK is cleaned. For this purpose, a supply fitting A2 of the rotary pressure filter 200 is connected to a supply line 318 for washing medium WM, for example a washing liquid. The washing medium WM passes through the supply fitting A2 into the washing zone Z2 and spreads there.

The amount of washing medium WM that reaches the washing zone Z2 per unit of time is determined via a metering valve 320. The supply line 318 is also assigned a pressure sensor 322 and a flow rate sensor 324.

The washing medium WM penetrates the filter cake FK and the filter medium 238 in order to then pass through the relevant discharge opening 240 into the relevant discharge line 242. The discharge lines 242 of all the filter cells 236, 237, which are currently in connection with the zone Z2 in the snapshot according to FIG. 2, are supplied to a washing liquid collecting container (not shown) through a ring segment chamber (not shown in FIG. 3) by means of a stationary discharge line (also not shown), which washing liquid collecting container can be followed by a separating stage in order to separate the washed-out liquid components from the cake from the washing liquid and to be able to use the washing liquid for a new washing process.

The circulating discharge lines 242 located in the washing zone Z2 form a first portion of a discharge line 326 assigned to the washing zone Z2, while the stationary discharge line (not shown) forms a second portion of this discharge line 326. Various sensors can also be assigned to the discharge line 326, for example a conductivity sensor and/or a turbidity sensor and/or a pH value sensor, which are represented in FIG. 1 by the sensor 328 and three points.

In the course of the further rotation of the filter drum 212, the cell group 236/237 is separated from the washing zone Z2 as it passes the zone separating means 232 and comes into connection with the drying zone Z3, which serves to dry the filter cake FK washed in the washing zone Z2. For this purpose, a supply fitting A3 of the rotary pressure filter 200 is connected to a supply line 330 for drying medium TM, for example drying air. The drying medium TM passes through the supply fitting A3 into the drying zone Z3 and spreads there.

The amount of drying medium TM that reaches the drying zone Z3 per unit of time is determined via a metering valve 332. The supply line 330 is also assigned a pressure sensor 334 and a flow rate sensor 336.

In the drying zone Z3, the drying medium TM passes through the filter cake FK and the filter medium 238 and can in turn reach the control head 246 through the relevant discharge opening 240 and the relevant associated discharge line 242. There, the drying medium TM is fed to a further ring segment chamber (not shown) of the stator 248 and can escape into the atmosphere therefrom through a stationary discharge line (also not shown), which together form a discharge line 338, or can be supplied to a separating device 340 in which the liquid components discharged from the filter cake FK by the drying medium TM can be separated.

In addition to a pressure sensor 342, at least one further sensor 344, for example an oxygen partial pressure sensor, can also be assigned to the discharge line 338 and/or the separating device 340. A cake thickness sensor 346 can also be provided in the drying zone Z3.

When the filter cells 236, 237 have passed through the zone separating means 232 between the drying zone Z3 and the ejection zone Z4, the treatment is ended and the filter cake FK can be ejected via a discharge line 348, preferably designed as an ejection chute. According to FIG. 1, at least one quality sensor 349 is assigned to the ejection chute 348, which sensor detects the quality of the ejected filter cake. A possible quality sensor 349 can be designed, for example, as a residual moisture sensor.

The ejection of the filter cake FK can be facilitated by an ejector scraper 262, which can be introduced into the filter cells 236, 237 and later withdrawn again by means of a fluidically, preferably pneumatically, actuatable power device (not shown). The supply line for actuating fluid leading to this power device is denoted by 350 in FIG. 1, the metering valve assigned to this supply line 350 by 352 and the pressure sensor assigned to the supply line 350 by 354.

Furthermore, the ejection of the filter cake can be facilitated by blowing back using blowback gas, preferably blowback air, which in particular helps to detach the filter cake FK from the filter medium 238. The blowback gas can be supplied via a supply line 356 which is at least partially formed by the lines 242 arranged in the ejection zone Z4. The supply line 356 is in turn assigned a metering valve 358 and a pressure sensor 360.

A washing nozzle 268 can also be provided in the ejection zone Z4, by means of which any filter cake residues in the cells 236, 237 can be washed out. The washing nozzle 268 can be connected to a supply line 362 for filter cloth rinsing medium, which supply line in turn can be assigned a metering valve 364, a pressure sensor 366 and a flow rate sensor 368. The cleaning of the filter cloth can also be supported by blowback gas. The blowback gas can be supplied via a supply line 370 which is at least partially formed by the lines 242 arranged in the ejection zone Z4. The supply line 370 is in turn assigned a metering valve 372 and a pressure sensor 374.

Furthermore, the discharge line 270 for filter cloth rinsing medium can be assigned a turbidity sensor 271, the degree of turbidity being used as a measure of the completeness of the discharge of the filter cake FK.

Finally, to prepare the filter cells 236, 237 for the next filtration cycle, the filter medium 238, for example the filter cloth, can be placed against the bottom of the relevant filter cell or a support mesh (not shown) provided there by a gas surge. The gas for this gas surge can be supplied via a supply line 376 which in turn can be assigned a metering valve 378 and a pressure sensor 380.

At least one further sensor can also be assigned to the drive motor 260, for example a rotational speed sensor and/or a drive power sensor and/or a torque sensor and/or a sensor for the power consumed by the drive device 260. The at least one further sensor is represented in FIG. 1 by the sensor 382 and three points.

Furthermore, sensors, for example wear sensors, can be assigned to the sealing devices of the rotary pressure filter 200, i.e. to the sealing assemblies 234 formed, for example, by stuffing box packings, and to the zone separating elements 232. In addition, a sensor can be provided which detects the fill level in a storage container for lubricant, for example lubricant for the rotor bearings 222, and/or a sensor for detecting the moisture content of the lubricant. All of these sensors are indicated in FIG. 1 by the sensor 384.

It should be added that all the sensors 306, 308, 310, 316, 322, 324, 328, 334, 336, 342, 344, 346, 349, 354, 360, 366, 368, 374, 380, 382 and 384 transmit the detection signals thereof to the control device 400 via a signal line 404, and that all the metering valves 304, 320, 332, 352, 356, 364, 372 and 378 receive the adjusting signals thereof from the control device 400 via a signal line 402. In addition, a metering pump can be provided instead of one or more of the metering valves.

It should also be added that all of the above-mentioned flow rate sensors can be formed by a mass flow sensor and/or a volumetric flow sensor.

As shown in FIG. 4, the decentralised control device 400 comprises a monitoring unit 406, which is connected via an input unit 408 and an output unit 410 to a central control device (not shown) which is part of a higher-level production system in which the rotary pressure filter module 100 is integrated.

The monitoring unit 406 serves to monitor compliance with manipulated variables which have been transmitted thereto by a manipulated variable determination unit 412. It does this by outputting appropriate adjusting signals via the signal line 402 to the metering valves 304, 320, 332, 352, 356, 364, 372 and 378 (hereinafter collectively referred to as “metering valves 414” for the sake of simplicity) and to monitor the response thereto on the basis of the detection signals transmitted thereto from the sensors 306, 308, 310, 316, 322, 324, 328, 334, 336, 342, 344, 346, 349, 354, 360, 366, 368, 374, 380, 382 and 384 (hereinafter collectively referred to as “sensors 416” for the sake of simplicity).

The manipulated variable determination unit 412 determines the manipulated variables on the basis of the production specifications received from the central control device of the production system via the input unit 408, taking into consideration the detection signals received from the sensors 416, which have been forwarded to the determination unit by the monitoring unit 406. The production specifications can contain, for example, information about the type of product FG to be filtered, the amount of filter cake FK to be ejected per unit of time, the quality of the filter cake FK to be ejected, and the like.

For example, the manipulated variable determination unit 412 can determine the manipulated variables using artificial intelligence, preferably an artificial intelligence that is continuously learning. The artificial intelligence can advantageously comprise at least one adaptive decision tree and/or at least one neural network, which can be generated on the basis of training data that are stored in a memory unit 418.

The training data stored in the memory unit 418 can already have been stored there when the rotary pressure filter module 100 was first put into operation and, for example, recorded on other rotary pressure filter modules of the same design. However, it is also possible to record training data while the rotary filter arrangement 100 is in operation and to store it in the memory unit 418. In this case, the artificial intelligence learns from the experiences it has made itself. It may be necessary to overwrite older training data when storing new training data.

The continuity of further learning does not have to be permanent or stepless continuity. Rather, it is also possible to retrain the artificial intelligence again and again only at predetermined time intervals. In addition, the training of the artificial intelligence does not need to be taken over by the decentralised control device 400 itself. Rather, it is also conceivable to transmit all the data required for the training by means of a transmission unit 420 to a remote service centre in which the artificial intelligence of the manipulated variable determination unit 412 is mirrored, to carry out the training on this “mirror system” and to feed back the trained system to the decentralised control device 400 again.

In addition to the tasks explained above, the decentralised control device 400 can, for example, take on the following additional tasks:

Should the decentralised control device 400 determine, on the basis of the detection signals of the sensors 416 and the setting options of the metering valves 414, that the production specifications made thereto by the central control device of the production system cannot be fulfilled or can only be fulfilled with a loss of quality or quantity of the ejected filter cake FK or an increased consumption, in particular an economically unjustifiable increased consumption, of resources, for example washing medium WM, said decentralised control device can output a corresponding warning message to the central control device of the production system and request corrected production specifications therefrom.

In this context, it is also conceivable that the decentralised control device 400 submits suggestions to the central control device of the production system as to which production specifications could be complied with, taking into consideration a predetermined cost-benefit efficiency.

Furthermore, it is conceivable that the decentralised control device 400, based on the detection signals transmitted by the wear sensors 384 on the basis of a wear model, which can also be based on artificial intelligence, for example, makes a prediction as to when the next maintenance should be carried out at the latest, for example when lubricant needs to be refilled or seals need to be replaced.

1. A rotary pressure filter module, comprising:
a rotary pressure filter, comprising:
a first supply line for supplying a suspension to be filtered, the first supply line associated with:
a first sensor device, wherein the first sensor device determines at least one physical property of the suspension, and
a first adjusting device, wherein the first adjusting device influences a supply of the suspension,
a second supply line for supplying a washing medium, the second supply line associated with a second sensor device, wherein the second sensor device determines at least one physical property of the washing medium and a second adjusting device for influencing the supply of the washing medium,
a third supply line for supplying a drying medium, the third supply line associated with a third sensor device, wherein the third sensor device determines at least one physical property of the drying medium, as well as a third adjusting device for influencing the supply of the drying medium,
a first discharge line for discharging a mother filtrate, the first discharge line associated with a fourth sensor device, wherein the fourth sensor device determines at least one physical property of the mother filtrate discharged,
a second discharge line for discharging a washing filtrate, the second discharge line associated with a fifth sensor device, wherein the fifth sensor device determines at least one physical property of the discharged washing filtrate,
a third discharge line for discharging a filter cake, the third discharge line associated with a sixth sensor device, wherein the sixth sensor device determines at least one physical property of the discharged filter cake; and
a control device associated with the rotary pressure filter, comprising:
at least one signal input for supplying detection signals from sensor devices comprising the first sensor device, the second sensor device, the third sensor device, the fourth sensor device, the fifth sensor device, and the sixth sensor device, and
at least one signal output for outputting control signals to adjusting devices,
wherein a decentralised control device associated with the rotary pressure filter is arranged on the rotary pressure filter or in a vicinity of the rotary pressure filter and can be brought into a data exchange connection with a central control device of a higher-level production system via a signal input, wherein the rotary pressure filter module does not comprise the central control device.

2. The rotary pressure filter module of claim 1, wherein the decentralised control device comprises an input unit to receive an operating start signal from the central control device and at least one of a type of the supplied suspension, an amount of filter cake to be discharged, a quality of the discharged filter cake, and a type of operation mode.

3. The rotary pressure filter module of claim 1, wherein the decentralised control device comprises a manipulated variable determination unit to determine manipulated variables for one or more of the adjusting devices based on one or more detection signals provided by one or more of the sensor devices and based on information received from the central control device.

4. The rotary pressure filter module of claim 1, wherein the decentralised control device comprises a monitoring unit to monitor compliance with manipulated variables on the basis of the detection signals received from the sensor devices and to output corrective control signals to the adjusting devices.

5. The rotary pressure filter module of claim 1, wherein the decentralised control device comprises an output unit to transmit information about an operation of the rotary pressure filter module to the central control device.

6. The rotary pressure filter module of claim 3, further comprising a manipulated variable determination unit to determine the manipulated variables via one or more of (a) building a predetermined determination program in a manner of a fixedly predetermined decision tree or (b) accessing at least one multidimensional value table.

7. The rotary pressure filter module of claim 3, wherein the manipulated variable determination unit is equipped with artificial intelligence.

8. The rotary pressure filter module of claim 7, wherein the artificial intelligence comprises one or more of an adaptive decision tree or a neural network, wherein the one or more of the adaptive decision tree or the neural network is generated based on training data.

9. The rotary pressure filter module of claim 7, wherein the artificial intelligence comprises static intelligence.

10. The rotary pressure filter module of claim 7, wherein the artificial intelligence comprises adaptive intelligence.

11. The rotary pressure filter module of claim 10, wherein the decentralised control device comprises a memory unit for storing training data sets for the artificial intelligence.

12. The rotary pressure filter module of claim 1, wherein the rotary pressure filter has a fourth discharge line for discharging the drying medium, wherein a seventh sensor device is associated with the fourth discharge line.

13. The rotary pressure filter module of claim 12, wherein the fourth discharge line is connected to a separating device, wherein the separating device is designed to separate the drying medium from residual filtrate.

14. The rotary pressure filter module of claim 1, wherein the rotary pressure filter comprises a cake thickness sensor.

15. The rotary pressure filter module of claim 1, wherein the rotary pressure filter comprises a fourth supply line for supplying a filter cake blowback medium, wherein a seventh sensor device is associated with the filter cake blowback medium.

16. The rotary pressure filter module of claim 1, wherein the rotary pressure filter comprises a fifth supply line for supplying filter cloth rinsing liquid, wherein a seventh sensor device comprising one or more of a pressure sensor or a pressure flow rate sensor is associated with the fifth supply line.

17. The rotary pressure filter module of claim 1, wherein the rotary pressure filter comprises a sixth supply line for supplying a filter cloth blowback medium, wherein a seventh sensor device comprising a pressure sensor is associated with the sixth supply line.

18. The rotary pressure filter module of claim 1, wherein the rotary pressure filter comprises a seventh supply line for supplying pressing medium, wherein a seventh sensor device comprising a pressure sensor is associated with the seventh supply line.

19. The rotary pressure filter module of claim 1, wherein a seventh sensor device comprising one or more of a rotational speed sensor, a torque sensor, or a sensor for power consumed by a drive device of the rotary pressure filter is associated with the drive device.

20. The rotary pressure filter module of claim 1, wherein a wear sensor is associated with at least one sealing element of the rotary pressure filter.
